(19) United States
(12) Patent Application Publication
(10) Pub. No.: US 2026/0331854 A1
(43) Pub. Date: Oct. 22, 2026

(54) EXTERIOR SURROUNDING ELEMENT ATTACHMENT APPARATUS

(71) Applicant: Yazaki Corporation, Tokyo (JP)

(72) Inventors: Toshiaki Anzai, Shizuoka (JP); Tomoki Hayashi, Shizuoka (JP)

(21) Appl. No.: 19/645,432

(22) Filed: Apr. 13, 2026

(30) Foreign Application Priority Data
Apr. 21, 2025 (JP) 2025-069431

(51) Int. Cl. H01R 43/20

(52) U.S. Cl. CPC H01R 43/20

(57) ABSTRACT

A pre-attachment device (exterior surrounding element attachment apparatus) is configured to attach one or more exterior surrounding elements to one or more connector-combined electric wires including a plurality of connectors and electric wires interconnected between the plurality of connectors. The pre-attachment device is configured to use an electric wire holding section to align the plurality of connectors in line in a predetermined order and to hold the plurality of connectors, with the electric wires being suspended from the connectors respectively in a direction of gravity. The pre-attachment device is further configured to perform an attachment operation of the one or more exterior surrounding elements to the electric wires while the plurality of connectors is conveyed together with the electric wire holding section in a conveyance direction.

### BACKGROUND OF THE INVENTION

### Technical Field

The present invention relates to an exterior surrounding element attachment apparatus configured to attach one or more exterior surrounding elements to one or more connector-combined electric wires including electric wires with connectors.

### Background Art

Conventionally, it is known that a connector-combined electric wire is routed on a wiring board and e.g. various exterior surrounding elements are attached to produce a wire harness, wherein the connector-combined electric wire has been previously produced e.g. by inserting terminals of terminal-combined electric wires into connectors (see e.g. Patent Document 1). According to the Patent Document 1, a connector-combined electric wire with a final harness form which is compressed is produced on a subassembly line. The connector-combined electric wire is then transferred to and routed on a wiring board on a main line, wherein e.g. one or more exterior surrounding elements are subsequently attached to produce a wire harness.

### CITATION LIST

### Patent Literature

Patent Document 1: JP 2001-319531 A

### SUMMARY OF THE INVENTION

In a routing operation of the connector-combined electric wire on the wiring board, electric wires interconnected between a plurality of connectors tend to be tangled, which may result in burdens on an operator during production of the wire harness.

Therefore, the present invention is focused on the above-described problem, and an objective of the present invention is to provide an exterior surrounding element attachment apparatus which enables burdens on an operator to be reduced.

The present invention relates to an exterior surrounding element attachment apparatus configured to attach one or more exterior surrounding elements to one or more connector-combined electric wires including a plurality of connectors and electric wires interconnected between the plurality of connectors, the exterior surrounding element attachment apparatus including: an electric wire holding section having an elongated shape and configured to align the plurality of connectors in line in a predetermined order and to hold the plurality of connectors, with the electric wires being suspended from the connectors respectively in a direction of gravity, wherein the exterior surrounding element attachment apparatus is configured to perform an attachment operation of the one or more exterior surrounding elements to the electric wires while the plurality of connectors is conveyed together with the electric wire holding section in a length direction of the electric wire holding section.

The present invention enables an exterior surrounding element attachment apparatus to be provided which allows burdens on an operator to be reduced.

### BRIEF DESCRIPTION OF THE DRAWINGS

FIG. 1 schematically shows a harness production system according to an embodiment;

FIG. 2 schematically shows an exemplary wire harness produced by means of the harness production system according to FIG. 1;

FIG. 3 shows a perspective view of a pre-attachment device as shown in FIG. 1;

FIG. 4 schematically shows several first ones of a series of operations performed in a pre-attachment step of the pre-attachment device as shown in FIG. 3;

FIG. 5 schematically shows the remaining ones of the series of operations performed in the pre-attachment step of the pre-attachment device as shown in FIG. 3 that follow the first operations as shown in FIG. 4;

FIG. 6 shows a perspective view of a post-attachment device as shown in FIG. 1; and

FIG. 7 shows an enlarged view of an end frame positioned at one of opposite ends of arrangement of a plurality of triangular frames as shown in FIG. 6.

### DETAILED DESCRIPTION OF THE PREFERRED EMBODIMENTS

Hereinafter, embodiments of a harness production system and a harness production method will be described.

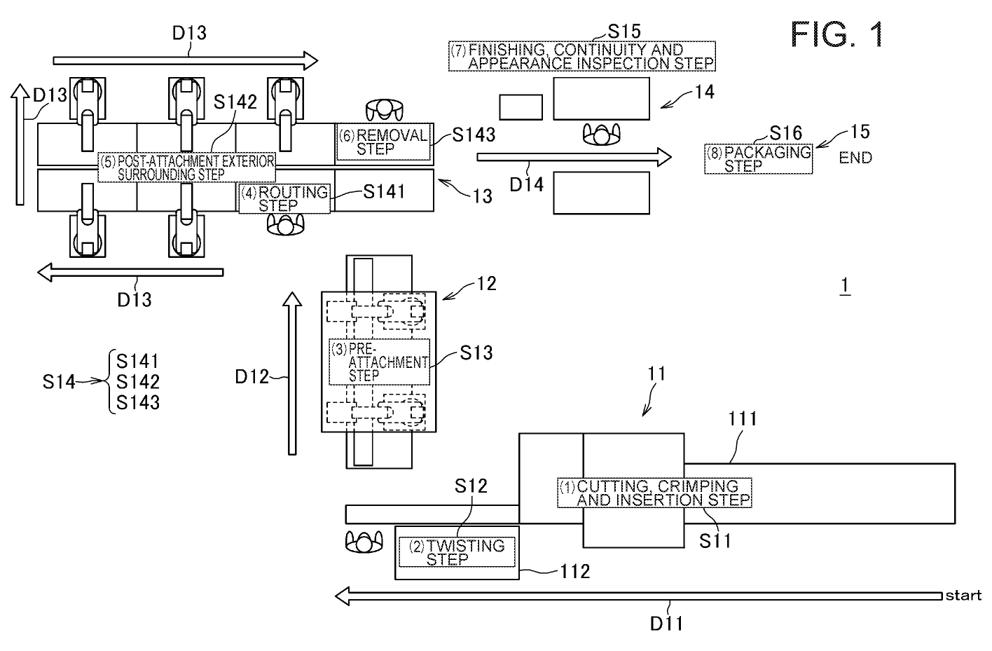

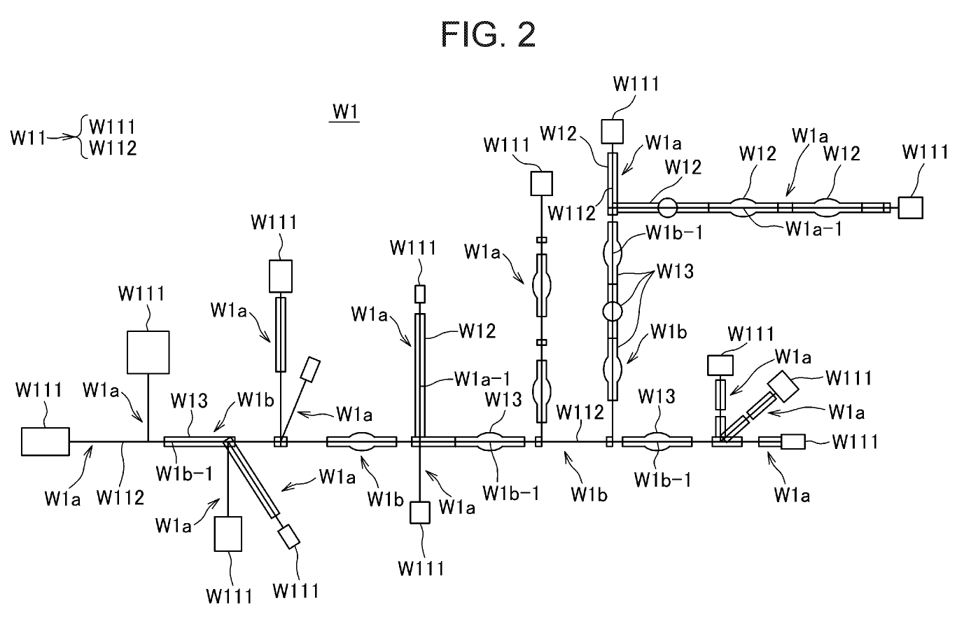

FIG. 1 schematically shows a harness production system according to an embodiment. FIG. 2 schematically shows an exemplary wire harness produced by means of the harness production system according to FIG. 1.

The harness production system 1 according to the present embodiment is configured to perform a harness production method including a series of operations including an electric wire cutting process and various inspections and a packaging process of final products as well as all operations therebetween. This harness production system 1 is configured to produce one or more wire harnesses W1 having a branched form as shown in FIG. 2 by way of example.

Such a wire harness W1 includes one or more connector-combined electric wires W11 as well as one or more branch line exterior surrounding elements (corresponding to the “one or more exterior surrounding elements”) W12 and one or more trunk line exterior surrounding elements W13 attached to the one or more connector-combined electric wires W11, the one or more connector-combined electric wires W11 including a plurality of connectors W111 and electric wires W112 interconnected between the plurality of connectors W111. The one or more branch line exterior surrounding elements W12 are attached to one or more target branch line portions W1a-1 of one or more electric wire portions of the one or more connector-combined electric wires W11 that are intended to define one or more branch lines W1a when routing the one or more connector-combined electric wires W11, i.e., in a completed state as shown in FIG. 2, each of the one or more branch lines W1a extending to a first branch junction from a corresponding one of the plurality of connectors W111. The trunk line exterior surrounding elements W13 are attached to one or more target trunk line portions W1b-1 of one or more electric wire portions of the one or more connector-combined electric wires W11 that are intended to define one or more trunk lines W1b, the one or more trunk lines W1b being different from the one or more branch lines W1a.

The harness production system 1 according to the present embodiment is configured to perform a harness production method for producing one or more wire harnesses W1 having the branched form as described above. The harness production system 1 includes a connector-combined electric wire production device 11, a pre-attachment device 12 (corresponding to the “exterior surrounding element attachment apparatus”), a post-attachment device 13, a finishing and inspection area 14, and a packaging area 15.

The connector-combined electric wire production device 11 is configured to produce one or more connector-combined electric wires W11 including the plurality of connectors W111 and electric wires W112 of the above-mentioned wire harness W1. The connector-combined electric wire production device 11 includes a cutting, crimping and insertion device 111 and a twisting device 112. The cutting, crimping and insertion device 111 is configured to perform a cutting, crimping and insertion step S11, i.e., an electric wire measurement, cutting, terminal crimping, and insertion of terminals into connector housings, while individual parts are conveyed along a first conveyance direction D11. It is to be noted that the connector-combined electric wire production device 11 may be configured to produce the connector-combined electric wires W11 in the form of a single group of electric wires, wherein all of the plurality of connectors W111 are integrally connected through the electric wires W112. Alternatively, the connector-combined electric wire production device 11 may be configured to produce the connector-combined electric wires W11 in the form of a plurality of electric wire groups that are formed by grouping the plurality of connectors W111 into several groups, wherein connectors W111 of each of the electric wire group are connected through one or more electric wires W112. The twisting device 112 is configured to perform a twisting step S12 for twisting at least some of the electric wires W112 of the connector-combined electric wires W11 produced by means of the connector-combined electric wire production device 11. After the twisting step S12 by the twisting device 112, the one or more connector-combined electric wires W11 are placed on one or more jigs to be transported to the pre-attachment device 12, wherein the one or more jigs are configured for carrying the one or more connector-combined electric wires W11 by an operator.

The pre-attachment device 12 is configured to perform a pre-attachment step S13 for the unrouted connector-combined electric wires W11 while conveying the connector-combined electric wires W11 along a second conveyance direction D12, wherein in the pre-attachment step S13, the branch line exterior surrounding elements W12 are attached to the target branch line portions W1a-1. After this pre-attachment step S13, the one or more connector-combined electric wires W11 are placed on one or more additional jigs to be transported to the next post-attachment device 13, wherein the one or more additional jigs are configured for carrying the one or more connector-combined electric wires W11. After the pre-attachment step S13, the post-attachment device 13 is configured to receive the one or more connector-combined electric wires W11 to perform the following post-attachment step S14: In the post-attachment step S14, a routing step S141, a post-attachment exterior surrounding step S142, and a removal step S143 are performed. In the routing step S141, the one or more connector-combined electric wires W11 to which the pre-attachment step S13 has been applied are routed in the branched form of the wire harness W1. In the post-attachment exterior surrounding step S142, the one or more trunk line exterior surrounding elements W13 are attached to the one or more target trunk line portions W1b while the one or more connector-combined electric wires W11 which have been routed in the above-described manner are conveyed along a third conveyance direction D13, wherein in the third conveyance direction D13, the one or more connector-combined electric wires W11 are transferred to a plurality of operation areas subsequently. With the attachment of the trunk line exterior surrounding elements W13, the wire harness W1 is substantially completed. In the removal step S143, this wire harness W1 is removed from the post-attachment device 13. The pre-attachment device 12 and the post-attachment device 13 will be described in more details below with reference to other figures.

After being removed from the post-attachment device 13, the wire harness W1 is transported to the finishing and inspection area 14. In this finishing and inspection area 14, a finishing, continuity and appearance inspection step S15 is performed. In this finishing, continuity and appearance inspection step S15, a predetermined finishing process, electrical continuity inspection, and appearance inspection are successively performed along a predetermined direction of operation D14. When the wire harness W1 passes the series of inspections, it is transported as a final product to the packaging area 15. In the packaging area 15, a packaging step S16 is performed in which the wire harness W1 as the final product is packaged with a predetermined packaging element. With this packing step S16, the series of operations of the harness production method in the harness production system 1 according to the present embodiment is ended.

Next, the pre-attachment device 12 and post-attachment device 13 of the harness production system 1 will be described in more details. First, the pre-attachment device 12 will be described.

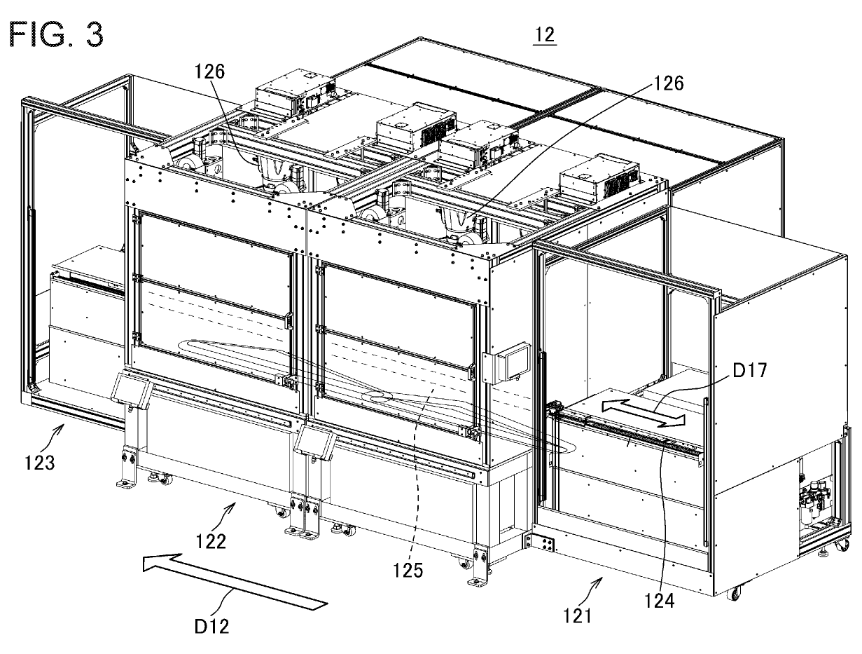

FIG. 3 shows a perspective view of the pre-attachment device 12 as shown in FIG. 1.

The pre-attachment device 12 is configured to receive the one or more connector-combined electric wires W11 from the connector-combined electric wire production device 11 and to attach the one or more branch line exterior surrounding elements W12 to the one or more target branch line portions W1a-1 of the electric wire portions of the one or more connector-combined electric wires W11 that are intended to define the one or more branch lines W1a, as described above. The pre-attachment device 12 includes a receiving area 121, an attachment area 122, a forwarding area 123, an electric wire holding section 124, and a conveyance rail 125. In the receiving area 121, a receiving step is performed in which the one or more connector-combined electric wires W11 are received from the connector-combined electric wire production device 11. In the attachment area 122, the one or more branch line exterior surrounding elements W12 are attached to the one or more connector-combined electric wires W11. In the forwarding area 123, a forwarding step is performed in which the one or more connector-combined electric wires W11 with the one or more branch line exterior surrounding elements W12 attached thereto are forwarded to the post-attachment device 13. The pre-attachment device 12 is configured to successively perform the operations in the above three areas via holding the one or more connector-combined electric wires W11 by the electric wire holding section 124 and via conveying the electric wire holding section 124 in the second conveyance direction D12 by the conveyance rail 125. The receiving area 121, attachment area 122, and forwarding area 123 are arranged in this order along the second conveyance direction D12, wherein the conveyance rail 125 extends through the three areas along the second conveyance direction D12.

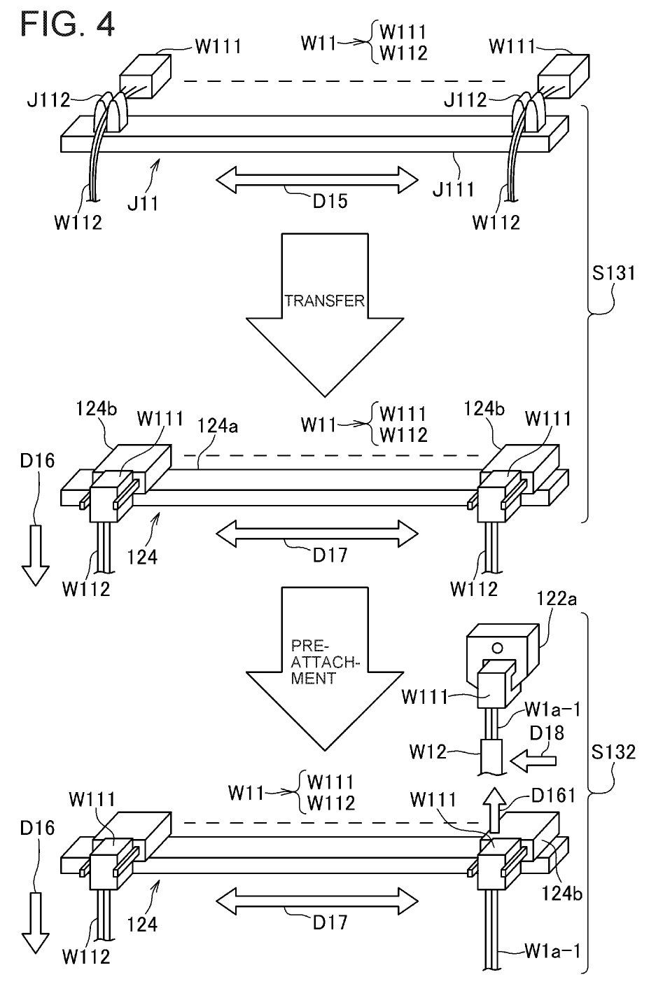

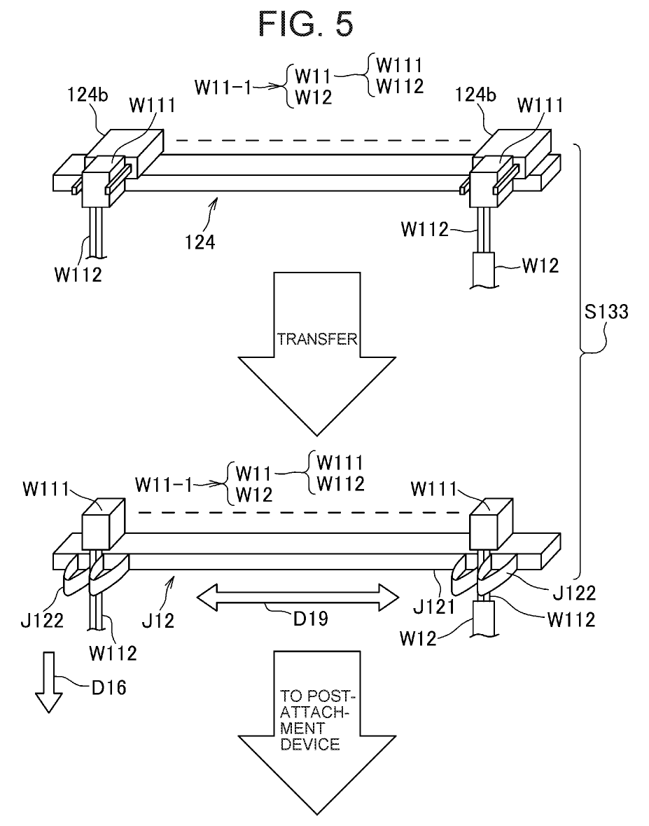

FIG. 4 schematically shows several first ones of the series of operations performed in the pre-attachment step of the pre-attachment device as shown in FIG. 3. FIG. 5 schematically shows the remaining ones of the series of operations performed in the pre-attachment step of the pre-attachment device as shown in FIG. 3 that follow the first operations as shown in FIG. 4.

In the pre-attachment step S13 by the pre-attachment device 12, first, the receiving step S131 of the connector-combined electric wires W11 from the connector-combined electric wire production device 11 is performed in the receiving area 121 by the following transfer process of the connector-combined electric wires W11. In this transfer process, the connector-combined electric wires W11 is transferred to the electric wire holding section 124 from a first holding jig J11 by an operator, wherein the first holding jig J11 is provided for carrying the connector-combined electric wires W11 from a pre-process. According to the present embodiment, the transfer process is manually performed by the operator.

The first holding jig J11 is a rod-shaped member including a main rod J111 and a plurality of electric wire clamping sections J112. The main rod J111 is an elongated rod member. The electric wire clamping sections J112 are configured to clamp and hold the electric wires W112 extending from the respective connectors W111 at the connector-combined electric wire production device 11, wherein the electric wires W112 are clamped at their portions closer to the respective connectors W111 by the electric wire clamping sections J112. A plurality of electric wire clamping sections J112 is arranged in line along a longitudinal direction D15 of the main rod J111. In the first holding jig J11, the connector-combined electric wires W11 are held by holding the electric wires W112 extending from all of the connectors W111 by means of the electric wire clamping sections J112. The first holding jig J11 holding the connector-combined electric wires W11 is carried to the receiving area 121 of the pre-attachment device 12 and set therein by the operator. In the receiving area 121, the connector-combined electric wires W11 are transferred to the electric wire holding section 124 from the first holding jig J11.

The electric wire holding section 124 is configured as an elongated section to hold the connector-combined electric wires W11 by holding the plurality of connectors W111. In the electric wire holding section 124, the connector-combined electric wires W11 are held with the electric wires W112 being suspended from the plurality of connectors W111 in a direction of gravity D16. The electric wire holding section 124 includes an elongated strip-shaped main body portion 124a and a plurality of connector holding sections 124b. Each of the connector holding sections 124b is a mechanism section configured to hold only one of the connectors W111. Each connector holding section 124b holds the connector W111 with a front side and a rear side of the connector W111 being oriented upward and downward along the direction of gravity D16 respectively, wherein the front side is intended to be joined with a partner connector and the electric wire W112 extends from the rear side. Such holding results in a suspended state of the electric wire W112 in the direction of gravity D16. In the electric wire holding section 124, a plurality of connector holding sections 124b as described above is arranged in line along the longitudinal direction D17 of the main body portion 124a.

In the receiving step S131 of the connector-combined electric wires W11, the connector-combined electric wires W11 are transferred from the first holding jig J11 to the electric wire holding section 124 as described above. This transfer is performed so that the plurality of connectors W111 is aligned in line in an order corresponding to a harness form of the wire harness W1 for subsequent exterior surrounding operation. According to the present embodiment, the receiving step S131 with transfer of the connector-combined electric wires W11 in the receiving area 121 is performed manually by the operator.

The pre-attachment device 12 includes a determining section configured to determine whether or not the plurality of connectors W111 is held in the predetermined order by the electric wire holding section 124. The determining section includes a camera and a controller, wherein the camera is configured to capture one or more images of the electric wire holding section 124 from above. The controller is configured to match image data captured by the camera with a master image to automatically determine whether or not the plurality of connectors W111 is aligned in a correct order of alignment. In the present example, the determining section is configured to simultaneously determine whether or not each of the connectors W111 is reliably held by a corresponding one of the connector holding sections 124b, in addition to the order of alignment of the plurality of connectors W111. When the determining section determines that the plurality of connectors W111 is aligned in an incorrect order of alignment or the connectors W111 are incompletely held by the connector holding sections 124b, the determining section issues an alert. In the receiving step S131, the determination by the determining section as described above is performed, wherein when the determination is positive, the process will proceed to a next step.

When the receiving step S131 is completed, the process proceeds to the pre-attachment exterior surrounding step S132 of the branch line exterior surrounding elements W12. The pre-attachment exterior surrounding step S132 is initiated with conveying the electric wire holding section 124 from the receiving area 121 to the attachment area 122 by means of the conveyance rail 125 as shown in FIG. 3. The conveyance rail 125 extends to connect the receiving area 121, the attachment area 122 and the forwarding area 123 in the longitudinal direction D17 of the electric wire holding section 124, as shown in FIG. 3. As the operations proceed, the conveyance rail 125 is configured to convey the electric wire holding section 124 from the receiving area 121 to the attachment area 122 and from the attachment area 122 to the forwarding area 123 in the second conveyance direction D12 that extends along the longitudinal direction D17 of the electric wire holding section 124.

In the pre-attachment exterior surrounding step S132, first, one or more of the plurality of connectors W111 are picked up from the connector holding section 124b, wherein each of the one or more of the plurality of connectors W111 includes a target branch line portion W1a-1 extending therefrom that is intended for attachment of the branch line exterior surrounding element W12. The one or more of the plurality of connectors W111 are picked up in a picking-up direction D161 by a predetermined picking-up mechanism 122a (corresponding to the “lifting section”) in the attachment area 122, wherein the picking-up direction D161 is oriented upward along the direction of gravity D16. Then, the branch line exterior surrounding element W12 is attached to each of the one or more target branch line portions W1a-1 suspended from the one or more picked-up connectors W111 in the direction of gravity D16, wherein the branch line exterior surrounding element W12 is attached to the target branch line portion W1a-1 laterally in an attachment direction D18. Examples of the branch line exterior surrounding elements W12 to be attached here include a tape for bundling the target branch line portions W1a-1, a fixing clip, and a corrugated tube. According to the present embodiment, this attachment of the branch line exterior surrounding elements W12 is performed by means of a plurality of work robotic arms 126 (FIG. 3) installed in the attachment area 122. After the attachment, the one or more connectors W111 are returned to the connector holding section 124b that previously held the one or more connectors W111. Once the above operations have been performed for all target branch line portions W1a-1, the pre-attachment exterior surrounding step S132 is ended, wherein the process then proceeds to a forwarding step S133 as shown in FIG. 5. The forwarding step S133 is initiated with conveying the electric wire holding section 124 from the attachment area 122 to the forwarding area 123 by means of the conveyance rail 125 as shown in FIG. 3.

The forwarding step S133 is performed in the forwarding area 123 to forward the connector-combined electric wires W11 as pre-attached electric wires W11-1 to the post-attachment device 13 as shown in FIG. 1, with the one or more branch line exterior surrounding elements W12 being attached to the connector-combined electric wires W11. In the forwarding step S133, the pre-attached electric wires W11-1 are transferred to a second holding jig J12 from the electric wire holding section 124, wherein the second holding jig J12 is provided for carrying the pre-attached electric wires W11-1 to the post-attachment device 13 by the operator.

The second holding jig J12 is configured similarly to the first holding jig J11 and includes an elongated main rod J121 and a plurality of electric wire clamping sections J122, wherein the plurality of electric wire clamping sections J122 is arranged in line along a longitudinal direction D19 of the main rod J121. However, the second holding jig J12 is configured to hold the electric wires W112 by means of the electric wire clamping sections J122 in an orientation that is different from that of the first holding jig J11. The electric wire clamping sections J122 of the second holding jig J12 are configured to clamp and hold the electric wires W112 extending from the respective connectors W111, with the front side and the rear side of each of the connectors W111 being oriented upward and downward along the direction of gravity D16, similarly to the connector holding sections 124b of the electric wire holding section 124.

In the forwarding step S133, the transfer of the pre-attached electric wires W11-1 is performed so that the order of the connectors W111 is maintained in which the connectors W111 are arranged in the electric wire holding section 124. This means that after completion of the transfer, the connector-combined electric wires W11 are held by the second holding jig J12 so that the connectors W111 are aligned in line again in the order corresponding to the harness form of the wire harness W1. According to the present embodiment, the forwarding step S133 with transfer of the connector-combined electric wires W11 in the forwarding area 123 is performed manually by the operator. The pre-attachment step S13 in the pre-attachment device 12 is ended with completion of the forwarding step S133, wherein the process then proceeds to the post-attachment step S14 in the post-attachment device 13.

In this manner, the pre-attachment device 12 enables the branch line exterior surrounding elements W12 to be attached to the connector-combined electric wires W11 without any burdens on the operator.

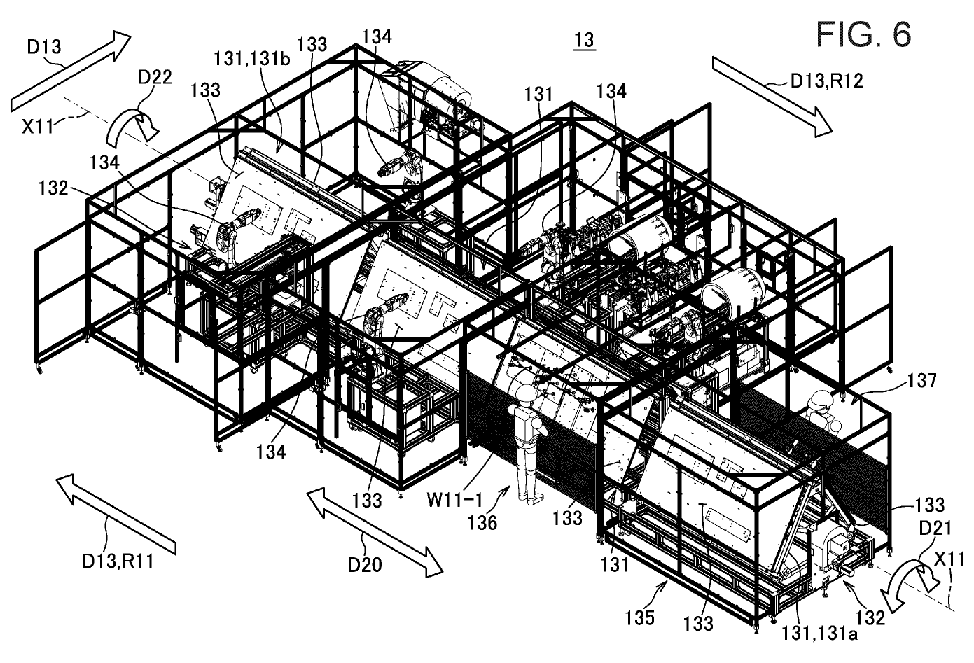

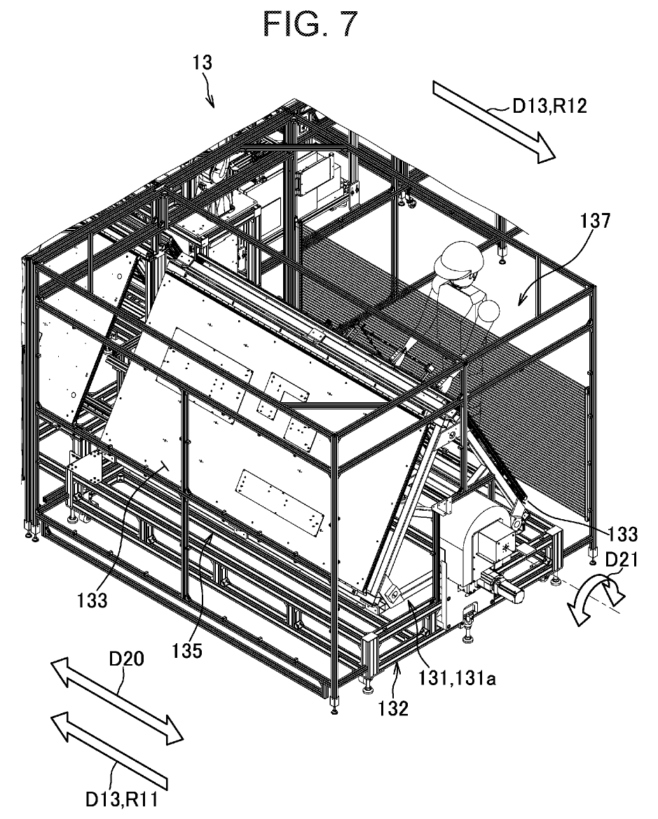

FIG. 6 shows a perspective view of the post-attachment device as shown in FIG. 1. FIG. 7 shows an enlarged view of an end frame positioned at one of opposite ends of arrangement of a plurality of triangular frames as shown in FIG. 6.

As described above, the post-attachment device 13 is configured to receive the above pre-attached electric wires W11-1 from the pre-attachment device 12 and perform the post-attachment step S14 including a routing process and an attachment process of the trunk line exterior surrounding elements W13. The post-attachment device 13 includes a plurality of triangular frames 131 (four triangular frames 131 in the shown example), a base frame 132, a plurality of wiring boards 133 (eight wiring boards 133 in the shown example), and a plurality of work robotic arms 134, wherein the wiring boards 133 are configured to be movable between the plurality of triangular frames 131.

Each of the triangular frames 131 is formed by metal frames that are assembled to have a triangular-tubular appearance, wherein the metal frames have a quadrilateral rod shape. The base frame 132 is formed by metal frames that are assembled to hold the triangular frames 131 in a horizontal pose in which a central axis X11 of the triangular-tubular shape extends in parallel to ground, wherein the metal frames have a quadrilateral rod shape. Each of the wiring boards 133 has a rectangular plate shape and is mountable to one of two faces of three faces of the triangular frame 131, the two faces being different from one of the three faces that is oriented toward ground, wherein the three faces define outer peripheral faces of the triangular frame 131. The pre-attached electric wires W11-1 are routed in the branched form of the wire harness W1 on the wiring boards 133.

Here, the base frame 132 according to the present embodiment holds the plurality of triangular frames 131 in such a manner that central axes X11 of the triangular frames 131 are aligned in line in an axial direction D20 to form a single continuous line. The wiring boards 133 are mounted to be movable along a pair of conveyance routes, wherein two of faces of each of the triangular frames 131 are aligned in-line along the central axis X11 to define the pair of conveyance routes, the two of the faces being different from one of the faces oriented toward ground. One of the pair of conveyance routes which is shown in the front in FIG. 6 is a first conveyance route R11 extending through a waiting area 135 and a routing area 136. The other of the pair of conveyance routes which is shown in the rear in FIG. 6 is a second conveyance route R12 extending through a removal area 137. The routing area 136 is provided for applying the routing step S141 as shown in FIG. 1 to the wiring boards 133. In the waiting area 135, the empty wiring boards 133 wait before routing. In the removal area 137, the removal step S143 as shown in FIG. 1 is applied to the wiring boards 133.

The base frame 132 holds a pair of end frames in such a manner that each of the end frames is rotatable around the central axis X11, wherein the end frames are arranged on opposite ends of arrangement of the plurality of triangular frames 131. Here, one of the pair of end frames which is shown at the right end in FIG. 6 is a first end frame 131a associated with the waiting area 135 and the removal area 137, wherein the first end frame 131a is shown in an enlarged view in FIG. 7. The other of the pair of end frames at the left end in FIG. 6 is a second end frame 131b which connects the operation areas for operation by the robotic arms 134. According to the present embodiment, the first end frame 131a is configured to be rotated in a first direction of rotation D21 in which the first end frame 131a is rotated from the removal area 137 toward the waiting area 135. On the other hand, the second end frame 131b is configured to be rotated in a second direction of rotation D22 opposite to the first direction of rotation D21 in which the second end frame 131b is rotated from the first conveyance route R11 toward the second conveyance route R12.

Each of the first end frame 131a and the second end frame 131b is rotated at an angular interval of 120° depending on how the operations have proceeded in the post-attachment device 13. By rotating the first end frame 131a with an angle of 120° in the first direction of rotation D21, one of faces of the first end frame 131a positioned in the removal area 137 on the second conveyance route R12 is moved into the waiting area 135 on the first conveyance route R11, wherein another of the faces of the first end frame 131a positioned in the waiting area 135 is moved toward ground. At the same time, another of the faces of the first end frame 131a oriented toward ground is moved into the removal area 137. On the other hand, by rotating the second end frame 131b with an angle of 120° in the second direction of rotation D22, one of faces of the second end frame 131b positioned in on the first conveyance route R11 is moved to the second conveyance route R12, wherein another of the faces of the second end frame 131b positioned on the second conveyance route R12 is moved toward ground. At the same time, another of the faces of the second end frame 131b oriented toward ground is moved to the first conveyance route R11.

The number of wiring boards 133 is fewer by one than a total number of faces of the plurality of triangular frames 131 except for faces oriented toward ground. In the example as shown in FIG. 6, seven wiring boards 133 are provided, namely fewer by one than eight, a total number of faces of the four triangular frames 131 except for faces oriented toward ground. Thus, one of the eight faces of the four triangular frames 131 is always empty that are different from faces of the triangular frames 131 oriented toward ground. The wiring boards 133 are moved by sliding along the first conveyance route R11 and the second conveyance route R12 to occupy the empty face.

Thus, by rotating the first end frame 131a, the wiring board 133 positioned in the removal area 137 on the second conveyance route R12 is moved to the waiting area 135 on the first conveyance route R11. This rotation of the first end frame 131a is initiated when a face of the first end frame 131a positioned in the waiting area 135 is empty. At the same time as a wiring board 133 is moved from the removal area 137 to the waiting area 135, an empty face of the first end frame 131a oriented toward ground is positioned in the removal area 137 to be ready for receiving a wiring board 133 from an adjacent triangular frame 131 via sliding movement.

By rotating the second end frame 131b, the wiring board 133 on the first conveyance route R11 is relayed through the second end frame 131b to the second conveyance route R12. Also during this relaying process, the rotation of the first end frame 131a is initiated when a face of the second end frame 131b positioned on the second conveyance route R12 is empty. At the same time as the wiring board 133 is relayed from the first conveyance route R11 to the second conveyance route R12 through the second end frame 131b, an empty face of the second end frame 131b oriented toward ground is positioned on the first conveyance route R11 to be ready for receiving a wiring board 133 from an adjacent triangular frame 131 via sliding movement.

In this manner, the post-attachment device 13 is configured in such a manner that the plurality of wiring boards 133 is circulated along the first conveyance route R11 and the second conveyance route R12 via route-to-route transfer by rotating the first end frame 131a and the second end frame 131b. Furthermore, transfer of each wiring board 133 is initiated when the operation on the wiring board 133 is ended and one of faces of a triangular frame 131 adjacent to the wiring board 133 in the route direction is empty. By such movement of the wiring boards 133, the pre-attached electric wires W11-1 are conveyed along the third conveyance direction D13 as shown in FIG. 1, wherein the trunk line exterior surrounding elements W13 are attached while conveying the pre-attached electric wires W11-1.

In the following description, processes of the post-attachment step S14 performed by the post-attachment device 13 will be described, particularly with reference to how one of the plurality of wiring boards 133 works that are circulated in the above-described manner. First, the routing area 136 is provided on a side of a second triangular frame 131 from right in FIG. 6 positioned on first conveyance route R11. When one wiring board 133 is moved to the routing area 136 from the right waiting area 135, the routing step S141 is initiated in which the pre-attached electric wires W11-1

coming from the pre-attachment device 12 are routed on the wiring board 133. This routing operation is performed manually by the operator. Then, when one face of a left adjacent triangular frame 131 has become empty, the wiring board 133 with the pre-attached electric wires W11-1 routed thereon is moved to the empty face via sliding along the first conveyance route R11. On the face that has received the wiring boards 133 with the pre-attached electric wires W11-1 routed thereon, the trunk line exterior surrounding elements W13 are attached to the electric wires W11-1 mounted on the wiring board 133, wherein the attachment of the trunk line exterior surrounding elements W13 is performed by a robotic arm 134 facing the triangular frame 131 that has received the wiring boards 133 with the pre-attached electric wires W11-1 routed thereon. Such attachment of trunk line exterior surrounding elements W13 is repeated until the wiring board 133 reaches the second end frame 131b. Then, after operation at the second end frame 131b is ended, the second end frame 131b is rotated to move the wiring board 133 to second conveyance route R12. On the second conveyance route R12 that has received the wiring boards 133, attachment of trunk line exterior surrounding elements W13 by a robotic arm 134 and sliding movement of the wiring board 133 are repeated similarly. This series of operations is ended with operation on one face of a triangular frame 131 adjacent to the removal area 137, the one face of the adjacent triangular frame 131 being opposite to the routing area 136. After this operation, all trunk line exterior surrounding elements W13 have been attached so that a wire harness W1 has been substantially completed, except for the finishing process in the finishing and inspection area 14. Examples of the trunk line exterior surrounding elements W13 attached in the previous processes include a tape, a fixing clip, and a corrugated tube that are same as or similar to those for the branch line exterior surrounding elements W12 as described above. Subsequently, the wiring board 133 slides to the removal area 137 and the removal step S143 is performed there, wherein the wire harness W1 is removed from the wiring board 133 and transported to the finishing and inspection area 14. The removal and transportation of the wire harness W1 is performed manually by the operator. The wiring board 133 that has become empty by removal of the wire harness W1 is moved to the waiting area 135 on the first conveyance route R11 by rotating the first end frame 131a, wherein the empty wiring board 133 waits for the routing process of next pre-attached electric wires W11-1.

The harness production system 1 and harness production method according to the above-described embodiment are provided in such a manner that the branch line exterior surrounding elements W12 are attached to the target branch line portions W1a-1 in the pre-attachment device 12 before the routing process on the wiring board 133 in the post-attachment device 13. Since the target branch line portions W1a-1 of the pre-attached electric wires W11-1 with the branch line exterior surrounding elements W12 attached thereto are bundled by means of the branch line exterior surrounding elements W12, corresponding suppression of spreading of the electric wires W112 is achieved so that tangling of the electric wires W112 is suppressed in the routing process on the wiring board 133. In other words, according to this embodiment, the wire harness W1 can be manufactured while reducing the burden on the operator by suppressing tangling of the electric wire W112 during routing on the wiring board 133.

In addition, the operator’s hand and/or robotic arm 134 may often have difficulties to access one or more electric wire portions on the wiring board 133 that are intended to define one or more branch lines in the routing process, wherein each of the one or more branch lines extends to a first branch junction from a corresponding one of the plurality of connectors W111. In contrast, the present embodiment is provided such that the branch line exterior surrounding elements W12 are attached to the target branch line portions W1a-1 of such one or more electric wire portions in the pre-attachment device 12 before the routing process on the wiring board 133. This pre-attachment process may enable burdens in manual operation on the wiring board 133 by the operator to be reduced and/or operation by the robotic arms 134 to be facilitated.

According to the present embodiment, the post-attachment device 13 includes the triangular frames 131, the base frame 132 holding the triangular frames 131 in the horizontal pose, and the wiring boards 133, wherein each of the wiring boards 133 is mountable to one of two faces of the triangular frames 131, the two faces being different from one face of the triangular frames 131 that is oriented toward ground. This configuration enables two wiring boards 133 to be mounted to one triangular frame 131 in an inclined state which makes it easily accessible to the operator and/or the robotic arm 134, which may enable efficient attachment of the trunk line exterior surrounding elements W13 in the post-attachment device 13 to be achieved.

Furthermore, the present embodiment is provided such that the base frame 132 holds the plurality of triangular frames 131 so that the central axes X11 are aligned in line in the axial direction D20. Furthermore, the wiring boards 133 are mounted to be movable along the first conveyance route R11 and the second conveyance route R12, wherein two of faces of each of the triangular frames 131 are aligned in-line along the central axis X11 to define the first conveyance route R11 and the second conveyance route R12, the two of the faces being different from one of the faces oriented toward ground. This configuration enables attachment of the trunk line exterior surrounding elements W13 to the target trunk line portions W1b-1 to be performed in a smooth work flow while moving the wiring boards 133. Furthermore, such a smooth work flow can be achieved along each of the first conveyance route R11 and second conveyance route R12, which enables efficient attachment of the trunk line exterior surrounding elements W13 to be achieved.

According to the present embodiment, the base frame 132 holds the first end frame 131a and the second end frame 131b in such a manner that the first end frame 131a and the second end frame 131b are rotatable around the central axis X11, wherein the first end frame 131a and the second end frame 131b are arranged on opposite ends of the arrangement. When being moved to reach one of the first end frame 131a and the second end frame 131b, each of the one or more wiring boards 133 is configured to be transferred from one to another of the first conveyance route R11 and the second conveyance route R12 by rotating the one of the first end frame 131a and the second end frame 131b around the central axis X11. The wiring boards 133 are circulated along the first conveyance route R11 and the second conveyance route R12 via the route-to-route transfer. This configuration enables attachment of the trunk line exterior surrounding elements W13 to be accomplished by using a long work route corresponding to one round of the above circulation, which enables increased degrees of freedom for the attachment to be achieved, such as an increase in types of components used for the trunk line exterior surrounding elements W13.

It is to be noted that the above-described embodiment merely shows a representative embodiment for the harness production system and harness production method. The harness production system and harness production method are not limited to the above embodiment, but may be modified and implemented in various manners.

For example, the above embodiment shows the wire harness W1 having the specific branched form as shown in FIG. 2 as an example of a wire harness to be produced. However, the produced wire harness is not limited thereto, but any specific branched form may be selected for the wire harness.

As an example of the harness production system, the above embodiment further shows the harness production system 1 including the connector-combined electric wire production device 11, the finishing and inspection area 14, and the packaging area 15 in addition to the pre-attachment device 12 and post-attachment device 13. As an example of the harness production method, the harness production method is illustrated which includes the cutting, crimping and insertion step S11, the twisting step S12, the finishing, continuity and appearance inspection step S15, and the packaging step S16 in addition to the pre-attachment step S13 and the post-attachment step S14. However, the harness production system and harness production method are not limited to this example. The harness production system may or may not include additional devices or operation areas, provided that the harness production system includes the pre-attachment device and the post-attachment device. Likewise, the harness production method may or may not include additional steps, provided that the harness production method includes the pre-attachment step and the post-attachment step.

As an example of the pre-attachment device, the above embodiment further shows the pre-attachment device 12 that has the specific configuration as shown in FIGS. 3 to 5. However, the pre-attachment device is not limited thereto, but any specific configuration may be selected for the pre-attachment device.

As examples of the pre-attachment device and post-attachment device, the above embodiment further shows the pre-attachment device 12 and post-attachment device 13 in which the branch line exterior surrounding elements W12 and the trunk line exterior surrounding elements W13 are attached by the robotic arms 126, 134. Furthermore, the pre-attachment device 12 is configured in such a manner that the transfer process of the connector-combined electric wires W11 from the first holding jig J11 and the transfer process of the pre-attached electric wires W11-1 to the second holding jig J12 are performed manually by an operator, wherein the first holding jig J11 is provided for carrying the connector-combined electric wires W11 from the pre-process and the second holding jig J12 is provided for carrying the connector-combined electric wires W11 to the subsequent step. The post-attachment device 13 is also configured in such a manner that the routing process of the pre-attached electric wires W11-1 and the removal process of the wire harness W1 are performed manually by an operator. However, the pre-attachment device and post-attachment device are not limited thereto, but all operations in these devices may be performed automatically by mechanical devices such as robotic arms. Alternatively, the pre-attachment device and post-attachment device may include various work spaces and/or wiring boards, wherein operations related to the harness production may be performed manually by an operator.

As an example of the post-attachment device, the above embodiment further shows the post-attachment device 13 in which the triangular frames 131 are held in a horizontal pose by the base frame 132, wherein each of the wiring boards 133 is mounted to one of two of faces of each of the triangular frames 131 that are different from one of the faces oriented to ground. However, the post-attachment device is not limited thereto, but may include e.g. a frame structure which includes only one face for mounting one or more wiring boards for each triangular frame 131, the one face extending in parallel or perpendicularly to ground. However, the post-attachment device 13 that includes two faces for mounting one or more wiring boards 133 for each triangular frame 131 enables efficient attachment of the trunk line exterior surrounding elements W13, as described above.

As an example of the post-attachment device, the above embodiment further shows the post-attachment device 13 in which the wiring boards 133 are movable along the first conveyance route R11 and second conveyance route R12, wherein the first conveyance route R11 and second conveyance route R12 are defined by the plurality of triangular frames 131. However, the post-attachment device is not limited thereto, but may be configured e.g. in such a manner that one or more wiring boards is movable only along one conveyance route. However, the above embodiment enables the operations to be performed while moving the wiring boards 133 along the first conveyance route R11 and second conveyance route R12, which enables efficient attachment of the trunk line exterior surrounding elements W13, as described above.

As an example of the post-attachment device, the above embodiment further shows the post-attachment device 13 in which the base frame 132 holds the first end frame 131a and second end frame 131b to be rotatable that are arranged on opposite ends of the arrangement. However, the post-attachment device is not limited thereto. For example, all of the plurality of arranged triangular frames may be arranged to be non-rotatable, wherein the one or more wiring boards may be transferred between the first conveyance route and second conveyance route manually by an operator. Alternatively, the operations may be performed without route-to-route transfer of the one or more wiring boards between the first conveyance route and second conveyance route. However, the work route may be extended by circulating the one or more wiring boards via the route-to-route transfer with rotation of the first end frame 131a and second end frame 131b so that increased degrees of freedom for attachment of the one or more trunk line exterior surrounding elements W13 can be obtained, as described above.

### REFERENCE SIGNS LIST

1 Harness production system

11 Connector-combined electric wire production device

12 Pre-attachment device (exterior surrounding element attachment apparatus)

13 Post-attachment device

14 Finishing and inspection area

15 Packaging area

111 Cutting, crimping and insertion device

112 Twisting device

121 Receiving area

122 Attachment area

122a Picking-up mechanism (lifting section)

123 Forwarding area

124 Electric wire holding section

124a Main body portion

124b Connector holding sections

125 Conveyance rail

126, 134 Robotic arms

131 Triangular frames

131a First end frame

131b Second end frame

132 Base frame

133 Wiring boards

135 Waiting area

136 Routing area

137 Removal area

D11 First conveyance direction

D12 Second conveyance direction

D13 Third conveyance direction

D14 Direction of operation

D15, D17, D19 Longitudinal directions

D16 Direction of gravity

D161 Picking-up direction

D18 Attachment direction

D20 Axial direction

D21 First direction of rotation

D22 Second direction of rotation

J11 First holding jig

J12 Second holding jig

J111, J121 Main rods

J112, J122 Electric wire clamping sections

R11 First conveyance route

R12 Second conveyance route

S11 Cutting, crimping and insertion step

S12 Twisting step

S13 pre-attachment step

S131 Receiving step

S132 pre-attachment exterior surrounding step

S133 Forwarding step

S14 Post-attachment step

S141 Routing step

S142 Post-attachment exterior surrounding step

S143 Removal step

S15 Finishing, continuity and appearance inspection step

S16 Packaging step

W1 Wire harness

W1a Branch lines

W1a-1 Target branch line portions

W1b Trunk lines

W1b-1 Target trunk line portions

W11 Connector-combined electric wires

W11-1 Pre-attached electric wires

W12 Branch line exterior surrounding elements (exterior surrounding elements)

W13 Trunk line exterior surrounding elements

W111 Connectors

W112 Electric wires

X11 Central axis

What is claimed is:

1. An exterior surrounding element attachment apparatus configured to attach one or more exterior surrounding elements to one or more connector-combined electric wires including a plurality of connectors and electric wires interconnected between the plurality of connectors, the exterior surrounding element attachment apparatus comprising:
an electric wire holding section having an elongated shape and configured to align the plurality of connectors in line in a predetermined order and to hold the plurality of connectors, with the electric wires being suspended from the connectors respectively in a direction of gravity,
wherein the exterior surrounding element attachment apparatus is configured to perform an attachment operation of the one or more exterior surrounding elements to the electric wires while the plurality of connectors is conveyed together with the electric wire holding section in a length direction of the electric wire holding section.

2. The exterior surrounding element attachment apparatus according to claim 1, further comprising a determining section configured to determine whether or not the plurality of connectors is held in the predetermined order by the electric wire holding section.

3. The exterior surrounding element attachment apparatus according to claim 1, further comprising a lifting section configured to receive one or more connectors of the plurality of connectors from the electric wire holding section and to lift and lower the one or more connectors,
wherein the exterior surrounding element attachment apparatus is configured to attach the one or more exterior surrounding elements to one or more electric wires connected to the one or more connectors lifted from the electric wire holding section by the lifting section.
